(19) United States
(12) Patent Application Publication
(10) Pub. No.: US 2022/0055487 A1
(43) Pub. Date: Feb. 24, 2022

(54) METHOD OF STABLY DRIVING IN-WHEEL MOTOR VEHICLE

(71) Applicants: Hyundai Motor Company, Seoul (KR); Kia Corporation, Seoul (KR)

(72) Inventor: Young Seoul CHOI, Anyang-si (KR)

(73) Assignees: Hyundai Motor Company, Seoul (KR); Kia Corporation, Seoul (KR)

(21) Appl. No.: 17/370,235

(22) Filed: Jul. 8, 2021

(30) Foreign Application Priority Data
Aug. 24, 2020 (KR) 10-2020-0106014

(51) Int. Cl. B60L 15/20; B60K 7/00; B60L 3/00; B60L 53/20

(52) U.S. Cl. CPC B60L 15/20; B60K 7/0007; B60L 3/003; B60L 2240/24; B60L 3/0061; B60K 2007/0038; B60L 2240/461; B60L 53/20

(57) ABSTRACT

A method of stably driving an in-wheel motor vehicle having two drive motors mounted on an axle of the in-wheel motor vehicle between a left wheel and a right wheel of the in-wheel motor vehicle and configured to be drivable independently of each other for driving the left wheel and the right wheel respectively, may include detecting failure of one among the two drive motors or failure of one of two inverters electrically connected to and configured for driving the two drive motors, respectively; measuring each speed of the left wheel and the right wheel of the in-wheel motor vehicle and determining a speed difference between the speed of the left wheel and the speed of the right wheel; and controlling torque of a drive motor that operates normally among the two drive motors when the determined speed difference between the speed of the left wheel and the speed of the right wheel falls out of a preset range.

### CROSS-REFERENCE TO RELATED APPLICATION

The present application claims priority to Korean Patent Application No. 10-2020-0106014, filed Aug. 24, 2020, the entire contents of which is incorporated herein for all purposes by this reference.

### BACKGROUND OF THE INVENTION

### Field of the Invention

The present invention relates to a method of stably driving an in-wheel motor vehicle. More particularly, the present invention relates to a method of stably driving an in-wheel motor vehicle that can stabilize operation of an in-wheel motor vehicle by controlling torque of a normally operating drive motor when another one of a pair of drive motors fails during operation.

### Description of Related Art

With the growing needs to develop zero-emission vehicles for reducing carbon dioxide, fine dust and the like, commercial electric vehicles, including electric buses, have appeared.

Although most passenger electric vehicles employ a type of center motor, the electric buses utilize wheel motors. In electric vehicles with wheel motors, two motors are provided on an axle, and speed reducers are provided on the axle axially outward than the motors. Drive force of the drive motor is passed to a speed reducer to increase torque and the torque is transferred to the wheels to drive the vehicle.

The wheel motors have advantages in packaging and weight over the center motor. Also, turning stability may be improved by controlling each of the motor in the in-wheel motor vehicle. When the center motor or an inverter fails, the vehicle with the center motor cannot be driven. In the instant case, the driver may be put in a dangerous situation when the center motor or the inverter fails during high-speed drive or on an uphill or downhill. On the other hand, the vehicle with the in-wheel motor may be normally driven using another normally operating motor even when one of the motors or the inverters fails since the wheel motors are controlled and driven independently of each other. Nonetheless, driving stability may worsen due to slip of the vehicle when torque is applied to only one wheel and the vehicle may even overturn when excessive slip occurs.

Therefore, there is a need to provide a method according to which the driving stability of an in-wheel motor vehicle is enhanced when one motor or inverter fails.

The foregoing is intended merely to aid in the understanding of the background of the present invention, and is not intended to mean that the present invention falls within the purview of the related art which is already known to those skilled in the art.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method of stably driving an in-wheel motor vehicle. In the method, when one motor fails while driving, the in-wheel motor vehicle may be stably driven using the other motor that normally operates.

According to various aspects of the present invention, provided is a method of stably driving an in-wheel motor vehicle having two drive motors mounted on an axle of the in-wheel motor vehicle between a left wheel and a right wheel of the in-wheel motor vehicle and configured to be drivable independently of each other for driving the left wheel and the right wheel respectively, the method including: detecting failure of one among the two drive motors or failure of one of two inverters electrically connected to and configured for driving the two drive motors, respectively; measuring each speed of the left wheel and the right wheel of the in-wheel motor vehicle and determining a speed difference between the speed of the left wheel and the speed of the right wheel; and controlling torque of a drive motor that operates normally among the two drive motors when the determined speed difference between the speed of the left wheel and the speed of the right wheel falls out of a preset range.

According to various aspects of the present invention, provided is a method of stably driving an in-wheel motor vehicle having two drive motors mounted on an axle of the in-wheel motor vehicle between a left wheel and a right wheel of the in-wheel motor vehicle and configured to be drivable independently of each other for driving the left wheel and the right wheel respectively, the method including: detecting failure of one among the two drive motors or one of two inverters electrically connected to and configured for driving the two drive motors, respectively; measuring each speed of the left wheel and the right wheel of the in-wheel motor vehicle; and controlling torque of a drive motor that operates normally, among the two drive motors, when a wheel speed ratio between the speed of the left wheel and the speed of the right wheel falls out of a preset stability range determined on the basis of a steering angle of the in-wheel motor vehicle.

According to various exemplary embodiments of the present invention, the method of stably driving an in-wheel motor vehicle is disclosed. In the method, when one motor fails while driving, the in-wheel motor vehicle may be stably driven using the other motor that normally operates.

The methods and apparatuses of the present invention have other features and advantages which will be apparent from or are set forth in more detail in the accompanying drawings, which are incorporated herein, and the following Detailed Description, which together serve to explain certain principles of the present invention.

Other aspects and exemplary embodiments of the invention are discussed infra.

The above and other features of the invention are discussed infra.

### BRIEF DESCRIPTION OF THE DRAWINGS

FIG. 1 is a diagram illustrating a drive mechanism of an in-wheel motor vehicle;

FIG. 2 is a diagram illustrating a system configuration for stably driving an in-wheel motor vehicle according to various exemplary embodiments of the present invention;

FIG. 3 is a flowchart illustrating a method of stably driving an in-wheel motor vehicle according to various exemplary embodiments of the present invention;

FIG. 4 is a flowchart illustrating a method stably driving an in-wheel motor vehicle according to various exemplary embodiments of the present invention;

FIG. 5 is a diagram illustrating computation of turning radii of wheels at both sides of the in-wheel motor vehicle, according to the method of stably driving an in-wheel motor vehicle of the present invention; and

FIG. 6 is a graph showing analysis of driving data obtained by carrying out the method of stably driving an in-wheel motor vehicle according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it may be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

Like reference numerals denote like components throughout the specification. In the meantime, the terminology used herein is for describing various exemplary embodiments only and is not intended to be limiting. As used herein, the singular forms “a,” “an,” and “the” are intended to include the plural forms as well, unless the context clearly indicates otherwise. It will be further understood that the terms “comprise,” “include,” “have,” etc., when used in the present specification, specify the presence of stated components, steps, operations, and/or elements, but do not preclude the presence or addition of one or more other components, steps, operations, and/or elements thereof.

In the specification, a left wheel refers to a wheel positioned on the left when a driver sitting on a driver's seat faces the front of the vehicle. A right wheel refers to a wheel positioned on the right when the driver sitting on the driver's seat looks to the front of the vehicle. That is, the left wheel is a wheel on the driver's side, and the right wheel is a wheel on the passenger's side thereof.

Hereinafter, the present invention will be described in detail with reference to the accompanying drawings.

Two drive motors are provided in an in-wheel motor vehicle. Even if one drive motor fails, the vehicle may be driven by another drive motor until a certain torque is exceeded. Therefore, in a method of stably driving an in-wheel motor vehicle according to various exemplary embodiments of the present invention, the in-wheel motor vehicle may be driven stably when one of two drive motors or one of two inverters that are mounted on the in-wheel motor vehicle fails, that is, when torque is applied to only one wheel.

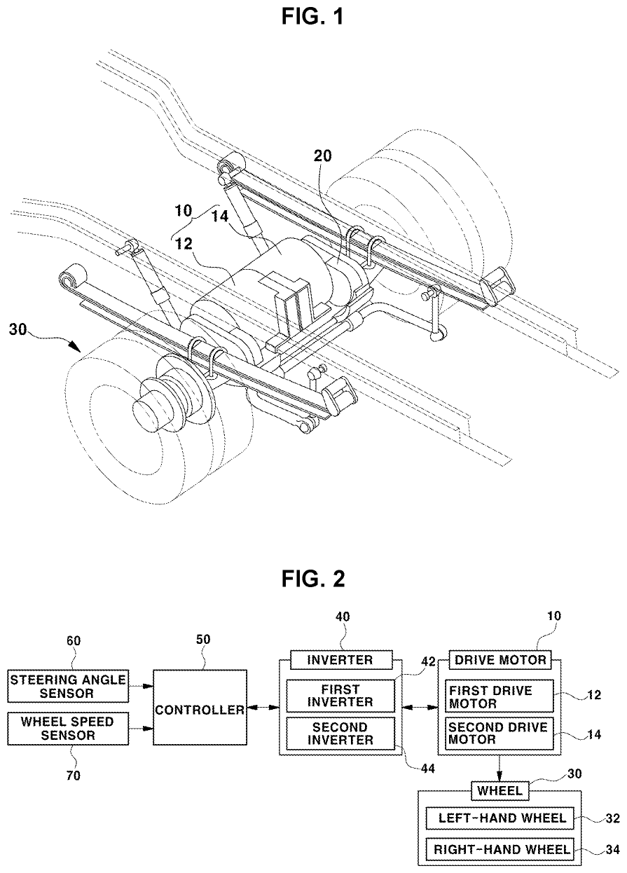

As illustrated in FIG. 1, according to various exemplary embodiments of the present invention, the in-wheel motor vehicle includes two drive motors 10 and speed reducers 20. The two drive motors 10 are provided on an axle, and the speed reducers 20 are placed axially outwardly to the two drive motors 10. Drive force of the two drive motors 10 is passed to the speed reducer 20 to increase torque and the torque is transferred to wheels 30 to drive the vehicle.

FIG. 2 is a diagram illustrating a system configuration for stably driving the in-wheel motor vehicle according to various exemplary embodiments of the present invention.

The two drive motors 10 generate drive force for the in-wheel motor vehicle. The two drive motors 10 include a first drive motor 12 and a second drive motor 14, each of which is configured in an independently controllable manner. Therefore, even if one of the two drive motors 10 fails, the in-wheel motor vehicle may be driven. In the exemplary embodiment, for convenience of description, one of the two drive motors 10 is referred to as the first drive motor 12, and the other as the second drive motor 14.

Each of the two drive motors 10 is controlled by each of inverters 40. Each inverter 40 receives direct current power from a high voltage battery provided in the vehicle and converts the direct current power into three-phase alternating current power supplied to the two drive motors 10. The inverters 40 are responsible for driving of, regenerative process for, and protection logic for the two drive motors 10. The inverters 40 include a first inverter 42 and a second inverter 44. In the exemplary embodiment, for convenience of description, like the two drive motors, one of the two inverters 40 is referred to as the first inverter 42, and the other as the second drive inverter 44. For example, the first inverter 42 controls the first drive motor 12, and the second inverter 44 controls the second drive motor 14.

According to various exemplary embodiments of the present invention, a controller 50 performs comprehensive control for driving the in-wheel motor vehicle. The controller 50 receives a torque request from the driver and provides a torque command to the inverters 40. On the basis of the provided torque command, the inverters 40 check a state of the two drive motors 10 and generate torque.

The controller 50 controls the inverters 40 and ultimately the two drive motors 10. Furthermore, the controller 50 receives a steering angle signal from a steering angle sensor (SAS) 60 provided in the in-wheel motor vehicle. The controller 50 also receives speed information related to each wheel 30 at both sides of the vehicle from a wheel speed sensor 70 of an anti-lock braking system (ABS) or an electronic braking system (EBS).

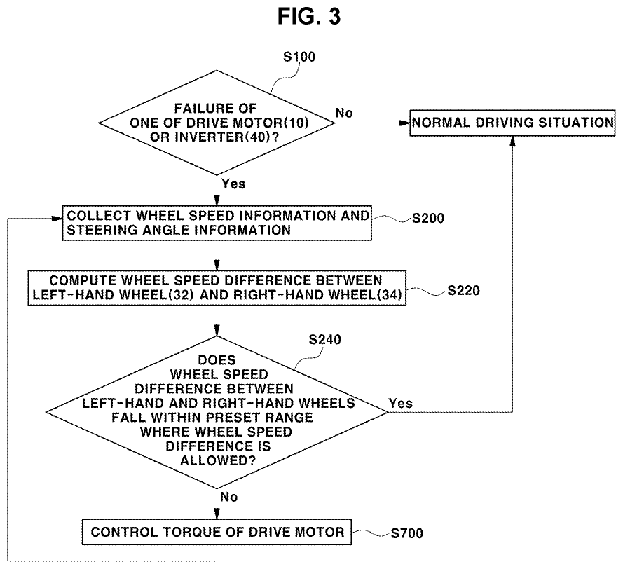

With reference to FIG. 3, the controller 50 determines whether any of the two drive motors 10 or the inverters 40 fails according to information from the inverters 40 (S100). In other words, on the basis of abnormality in three-phase electric current values the controller 50 may determine if any one of the first drive motor 12, the second drive motor 14, the first inverter 42 and the second inverter 44 has failed.

When it is determined that any of the first drive motor 12, the second drive motor 14, the first inverter 42, and the second inverter 44 has failed, according to various exemplary embodiments of the present invention, drive stabilization logic is used as follows.

The controller 50 collects wheel speed information and steering angle information related to the in-wheel motor vehicle, which are obtained by the sensors (S200). The wheel speed sensors 70 conveys speeds of the wheels 30 on both sides of the in-wheel motor vehicle, that is, a left wheel 32 and a right wheel 34 to the controller 50. A steering angle sensor 60 transmits a measured steering angle to the controller 50. When the inverter fails, rotation speed of the drive motor cannot be measured. To solve the present problem, according to various exemplary embodiments of the present invention, a configuration is employed in which wheel speed from the wheel speed sensor of the ABS or the EBS is used to measure the rotation speed of the drive motor without depending on a position sensor of the drive motor that has failed. Thus, the reliability of the in-wheel motor vehicle may be improved.

According to various exemplary embodiments of the present invention, the controller 50 determines a speed difference between the left wheel 32 and the right wheel 34 on the basis of information collected from the respective wheel speed sensors 70 of the left wheel 32 and the right wheel 34 (S220). The occurrence of the speed difference between the wheels 30 on both sides may indicate that the driving stability of the in-wheel motor vehicle has decreased. Thus, the controller 50 determines whether the speed difference between the wheels 30 at each side falls within a preset range where the wheel speed difference is allowed (S240). Unless the speed difference between the wheels 30 on both sides is in the preset range, the controller 50 performs torque control that either increases or decreases the output of the drive motor 10 that has not failed, that is, the drive motor 10 that operates normally (S700), improving the stability while driving the in-wheel motor vehicle.

The speed difference between the wheels 30 on both sides varies depending on whether the vehicle is moving along a straight road or along a curved road. Accordingly, it may be determined if torque control of the drive motor 10 is necessary, based on the steering angle measured by the steering angle sensor 60.

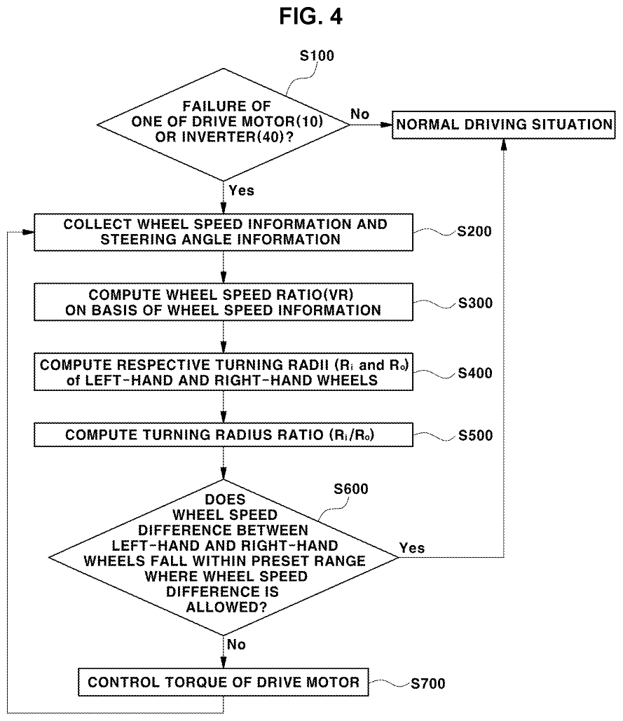

With reference to FIG. 4, the controller 50 determines whether the torque control is necessary, depending on whether a wheel speed ratio between the left wheel 32 and the right wheel 34 falls within a preset stability range which is determined on the basis of the steering angle of the in-wheel motor vehicle.

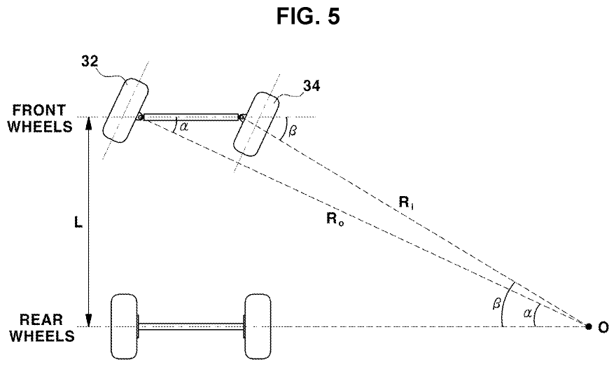

The speed difference between the wheels 30 on both sides may be expressed as a wheel speed ratio (VR) between the wheels 30 on both sides. As expressed in Equation 1, the controller 50 acquires the wheel speed ratio VR by dividing a speed vᵢ of an internal wheel by a speed vₒ of an external wheel (S300). At the present point, the internal wheel refers to a wheel which is positioned closer to a turning center point than the external wheel when the in-wheel motor vehicle turns along a curve, and the external wheel refers to a wheel which is positioned more remotely from the turning center point than the internal wheel when the in-wheel motor vehicle turns along the curve. FIG. 5 illustrates that the in-wheel motor vehicle turning along a right curve, in which the left wheel refers to the external wheel, and the right wheel refers to the internal wheel.

$$VR = \frac{{v}_{i}}{{v}_{o}} \qquad Equation 1$$

The controller 50 determines a turning radius of each wheel 30 on the basis of the steering angle received from the steering angle sensor 60 (S400). As illustrated in FIG. 5, the turning radius may be determined using the Ackermann-Jeantaud steering principle. According to the present principle, an extension line of a steering knuckle on the front wheel side meets the axis center portion of the rear wheel. When the vehicle turns along a curve, a steering angle of the internal wheel 34 which is positioned more radially inward toward a center point O than the external wheel 32 with respect to a center point O of turning is greater than a steering angle of the external wheel 32 which is positioned more outward than the internal wheel 34. When the vehicle turns along a right curve (as illustrated in FIG. 5), the left wheel 32 and the right wheel 34 becomes the external wheel 32 and the internal wheel 34, respectively. Therefore, for convenience in describing the case of turning along a right curve, the left wheel and the external wheel have the same reference numeral, and the right wheel and the internal wheel also have the same reference numeral.

According to various exemplary embodiments of the present invention, the turning radius Rᵢ, of the internal wheel 34 and the turning radius Rₒ of the external wheel 32 are determined using Equation 2 and Equation 3, respectively.

$${R}_{i} = \frac{L}{sin β} + {d}_{i} \qquad Equation 2$$

where Rᵢ denotes a turning radius of the internal wheel 34, L denotes a wheelbase, a distance between respective axes of the front wheel and the rear wheel of the in-wheel motor vehicle, β denotes a steering angle of the internal wheel 34, and dᵢ denotes a distance from a center portion of a kingpin to a center portion line of the internal wheel 34.

$${R}_{o} = \frac{L}{sin α} + {d}_{o} \qquad Equation 3$$

where Rₒ denotes a turning radius of the external wheel 32, L denotes the distance between the respective axes of the front wheel and the rear wheel of the in-wheel motor vehicle, α denotes a steering angle of the external wheel 32, and dₒ denotes a distance from the center portion of the kingpin to a center portion line of the external wheel 32. According to various exemplary embodiments of the present invention, when the turning radius of any one of the external wheel 32 and the internal wheel 34 is known, the turning radius of the other may be obtained by adding or subtracting a width of the in-wheel motor vehicle.

Therefore, the controller 50 may acquire a turning radius ratio Rᵢ/Rₒ which is a ratio of the internal wheel 34 to the external wheel 32 (S500). The controller 50 determines whether the wheel speed ratio VR falls within a preset stability range which is determined on the basis of the turning radius ratio Rᵢ/Rₒ (S600). If not, the controller 50 controls the output of the torque of the drive motor 10 that has not failed to stabilize motion of the in-wheel motor vehicle (S700).

According to various exemplary embodiments of the present invention, the preset stability range which is determined on the basis of the steering angle or the turning radius ratio Rᵢ/Rₒ is expressed as in Equation 4.

$$\{ \frac{{R}_{i}}{{R}_{0}} \times ( 1 - e ) \} < VR < \{ \frac{{R}_{i}}{{R}_{0}} \times ( 1 + e ) \} \qquad Equation 4$$

where e denotes an error ratio, and the error ratio, as a tuning factor, may be changed.

When it is determined that the wheel speed ratio VR falls out of the preset stability range which is determined using Equation 4, the controller 50 performs the control of the torque of the drive motor 10 that operates normally, that is, the drive motor 10 that has not failed (S700).

Above, described was the in-wheel motor vehicle turning along a right corner. When the in-wheel motor vehicle turns along a left corner, the left-side wheel 32 and the right wheel 34 becomes the internal wheel and the external wheel respectively, and Equations 1 to 4 may be applied same. In other words, the above may be applied for the case of turning along a left corner, except that the left wheel 32 and the right wheel 34 are switched. Therefore, repeating descriptions will be omitted.

As an example, the turning radius Rₒ of the external wheel, the turning radius Rᵢ of the internal wheel, the turning radius ratio Rᵢ/Rₒ, and the error ratio for the turning radius ratio Rᵢ/Rₒ are determined for a low-floor bus that has a maximum outside-wheel turning angle of 35°, a maximum steering angle of 990°, measured by the steering angle sensor, a distance of 5.4 m between respective axes of front and rear wheels, and a vehicle width of 2.49 m. The following Table 1 lists these radii and ratios.

TABLE 1

| Steering | | Turing | Turning | Ratio | | |
|---|---|---|---|---|---|---|
| Angle of | | Radius of | Radius of | between | | |
| External | Steering | External | internal | Turning | | |
| wheel | Angle | wheel | wheel | Radii | Error Ratio | |
| (α, °) | (SAS signal) | (Rₒ) | (Rᵢ) | (Rᵢ/Rₒ) | 97% | 103% |
| 5 | 141.4 | 62.0 | 59.5 | 0.960 | 0.931 | 0.989 |
| 10 | 282.9 | 31.1 | 28.6 | 0.920 | 0.892 | 0.948 |
| 15 | 424.3 | 20.9 | 18.4 | 0.881 | 0.854 | 0.907 |
| 20 | 565.7 | 15.8 | 13.3 | 0.842 | 0.817 | 0.868 |
| 25 | 707.1 | 12.8 | 10.3 | 0.805 | 0.781 | 0.829 |
| 30 | 848.6 | 10.8 | 8.3 | 0.769 | 0.746 | 0.793 |
| 35 | 990.0 | 9.4 | 6.9 | 0.736 | 0.713 | 0.758 |

For reference, the turning radius Rᵢ of the internal wheel in Table 1 is obtained by subtracting the vehicle width (2.49 m) from the turning radius Rₒ of the external wheel, which is determined using Equation 3. The error ratio, as a tuning factor, is a value which is changeable through vehicle stability testing. In the present instant experiment, an error ratio (e) of 3% was applied.

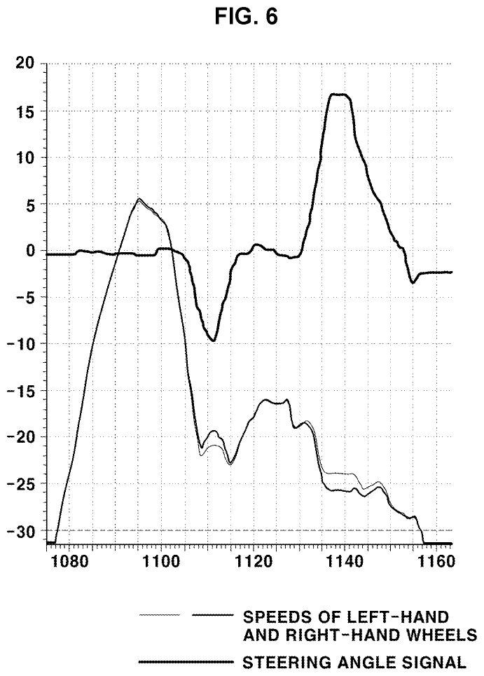

As a result of analyzing driving data of the bus on the basis of data in Table 1, it could be seen from FIG. 6 that the wheel speed difference between the left wheel and the right wheel occurred according to the steering angle (the wheel speed difference is indicated by a gap between graph lines for the wheel speeds of the left wheel and the right wheel in FIG. 6). Furthermore, it was checked that the wheel speed ratio VR fell within an error ratio range for the turning radius ratio (Rᵢ/Rₒ). According to various exemplary embodiments of the present invention, when the wheel speed ratio VR falls out of the error ratio range, the control of the torque of the drive motor that operates normally is introduced for the wheel speed ratio VR to fall within the error ratio range. Thus, the driving stability may be improved.

In an existing in-wheel motor vehicle, the output of the drive motor is derated only to move the vehicle to a safe place when one drive motor or inverter fails. The present output limitation is set due to stability. If the driving stability may be ensured, excessive output limitation is not required. According to various exemplary embodiments of the present invention, provided is a method of stably driving an in-wheel motor vehicle. In the method, the in-wheel motor vehicle is configured for being stably driven by utilizing the normally operating drive motor between the pair of motors and of stabilizing the vehicle by performing torque control when slippage occurs.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

In various exemplary embodiments of the present invention, each operation described above may be performed by a control device, and the control device may be configured by a plurality of control devices, or an integrated single control device.

In various exemplary embodiments of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of driving an in-wheel motor vehicle having two drive motors mounted on an axle of the in-wheel motor vehicle between a left wheel and a right wheel of the in-wheel motor vehicle and configured to be drivable independently of each other for driving the left wheel and the right wheel respectively, the method comprising:
determining, by a controller electrically-connected to two inverters, failure of one among the two drive motors or failure of one of the two inverters electrically connected to and configured for driving the two drive motors, respectively;
determining, by the controller, each speed of the left wheel and the right wheel of the in-wheel motor vehicle and determining a speed difference between the speed of the left wheel and the speed of the right wheel; and
controlling, by the controller, torque of a drive motor that operates normally among the two drive motors when the determined speed difference between the speed of the left wheel and the speed of the right wheel falls out of a preset range.

2. The method according to claim 1, wherein each speed of the left wheel and the right wheel is measured by a wheel speed sensor included in an anti-lock braking system (ABS) or an electronic braking system (EBS) of the in-wheel motor vehicle.

3. A non-transitory computer readable storage medium on which a program for performing the method of claim 1 is recorded.

4. A method of driving an in-wheel motor vehicle having two drive motors mounted on an axle of the in-wheel motor vehicle between a left wheel and a right wheel of the in-wheel motor vehicle and configured to be drivable independently of each other for driving the left wheel and the right wheel respectively, the method including:
determining, by a controller electrically-connected to two inverters, failure of one among the two drive motors or one of the two inverters electrically connected to and configured for driving the two drive motors, respectively;
determining, by the controller, each speed of the left wheel and the right wheel of the in-wheel motor vehicle; and
controlling, by the controller, torque of a drive motor that operates normally, among the two drive motors, when a wheel speed ratio between the speed of the left wheel and the speed of the right wheel falls out of a preset stability range determined according to a steering angle of the in-wheel motor vehicle.

5. The method according to claim 4, wherein the wheel speed ratio is determined from the following equation:
$$V R = \frac{{v}_{i}}{{v}_{o}}$$
where VR denotes the wheel speed ratio, vᵢ denotes a speed of an internal wheel which is positioned closer to a turning center point than an external wheel among the left wheel and the right wheel, when the in-wheel motor vehicle turns along a curve, and vₒ denotes a speed of the external wheel which is positioned more remotely from the turning center point than the internal wheel when the in-wheel motor vehicle turns along the curve.

6. The method according to claim 5, wherein the preset stability range is determined according to a turning radius of each of the internal wheel and the external wheel of the in-wheel motor vehicle.

7. The method according to claim 6, wherein the turning radius of the external wheel is determined from the following equation:
$${R}_{o} = \frac{L}{sin α} + {d}_{o}$$
where Rₒ denotes the turning radius of the external wheel, L denotes a distance between respective axes of the front wheel and the rear wheel of the in-wheel motor vehicle, α denotes a steering angle of the external wheel, and dₒ denotes a distance from a center portion of a kingpin to a center portion line of the external wheel, and
the turning radius of the internal wheel is determined from the following equation:
$${R}_{i} = \frac{L}{sin β} + {d}_{i}$$
where Rᵢ denotes the turning radius of the internal wheel, L denotes the distance between the respective axes of the front wheel and the rear wheel of the in-wheel motor vehicle, β denotes a steering angle of the internal wheel, and dᵢ denotes a distance from the center portion of the kingpin to a center portion line of the internal wheel.

8. The method according to claim 7, wherein the preset stability range is determined from the following equation:
$$\{ \frac{{R}_{i}}{{R}_{0}} \times ( 1 - e ) \} < VR < \{ \frac{{R}_{i}}{{R}_{0}} \times ( 1 + e ) \}$$
where e denotes a predetermined error ratio.

9. The method according to claim 4, wherein each speed of the left wheel and the right wheel is measured by a wheel speed sensor included in an anti-lock braking system or an electronic braking system of the in-wheel motor vehicle.

10. The method according to claim 4, wherein the steering angle of the in-wheel motor vehicle is measured by a steering angle sensor of the in-wheel motor vehicle.

11. A non-transitory computer readable storage medium on which a program for performing the method of claim 4 is recorded.

12. An in-wheel motor vehicle, comprising:
two drive motors mounted on an axle of the in-wheel motor vehicle between a left wheel and a right wheel of the in-wheel motor vehicle and configured to be drivable independently of each other for driving the left wheel and the right wheel, respectively,
two inverters electrically connected to and configured for driving the two drive motors;
a wheel speed sensor measuring each speed of the left wheel and the right wheel; and
a steering angle sensor measuring a steering angle of the in-wheel motor vehicle; and
a controller electrically-connected to the two inverters,
wherein the controller is configured to:
determining failure of one among the two drive motors or one of the two inverters;
determining each speed of the left wheel and the right wheel of the in-wheel motor vehicle; and
controlling torque of a drive motor that operates normally, among the two drive motors, when a wheel speed ratio between the speed of the left wheel and the speed of the right wheel falls out of a preset stability range determined according to the steering angle of the in-wheel motor vehicle.

13. The in-wheel motor vehicle according to claim 12, wherein the wheel speed ratio is determined from the following equation:
$$VR = \frac{{v}_{i}}{{v}_{o}}$$
where VR denotes the wheel speed ratio, vᵢ denotes a speed of an internal wheel which is positioned closer to a turning center point than an external wheel among the left wheel and the right wheel, when the in-wheel motor vehicle turns along a curve, and vₒ denotes a speed of the external wheel which is positioned more remotely from the turning center point than the internal wheel when the in-wheel motor vehicle turns along the curve.

14. The in-wheel motor vehicle according to claim 13, wherein the preset stability range is determined according to a turning radius of each of the internal wheel and the external wheel of the in-wheel motor vehicle.

15. The in-wheel motor vehicle according to claim 14, wherein the turning radius of the external wheel is determined from the following equation:
$${R}_{o} = \frac{L}{sin α} + {d}_{o}$$
where Rₒ denotes the turning radius of the external wheel, L denotes a distance between respective axes of the front wheel and the rear wheel of the in-wheel motor vehicle, a denotes a steering angle of the external wheel, and dₒ denotes a distance from a center portion of a kingpin to a center portion line of the external wheel, and
the turning radius of the internal wheel is determined from the following equation:
$${R}_{i} = \frac{L}{sin β} + {d}_{i}$$
where Rᵢ denotes the turning radius of the internal wheel, L denotes the distance between the respective axes of the front wheel and the rear wheel of the in-wheel motor vehicle, β denotes a steering angle of the internal wheel, and dᵢ denotes a distance from the center portion of the kingpin to a center portion line of the internal wheel.

16. The in-wheel motor vehicle according to claim 15, wherein the preset stability range is determined from the following equation:
$$\{ \frac{{R}_{i}}{{R}_{0}} \times ( 1 - e ) \} < VR < \{ \frac{{R}_{i}}{{R}_{0}} \times ( 1 + e ) \}$$
where e denotes a predetermined error ratio.
